(19) United States
(12) Patent Application Publication
(10) Pub. No.: US 2026/0369216 A1
(43) Pub. Date: Nov. 19, 2026

(54) DISPLAY PANEL, DISPLAY DEVICE, AND ELECTRONIC DEVICE

(71) Applicant: Samsung Display Co., Ltd., Yongin-si (KR)

(72) Inventors: WONJUN LEE, Yongin-si (KR); SUNGMIN SON, Yongin-si (KR); MINJI KIM, Yongin-si (KR); GEUMJU MOON, Yongin-si (KR)

(21) Appl. No.: 19/415,274

(22) Filed: Dec. 10, 2025

(30) Foreign Application Priority Data
May 16, 2025 (KR) 10-2025-0063672

(51) Int. Cl. G09G 3/32

(52) U.S. Cl. CPC G09G 3/32; G09G 2300/043; G09G 2300/0819; G09G 2310/0267; G09G 2310/0275; G09G 2320/0257

(57) ABSTRACT

A display panel includes: a pixel connected to a scan line and a data line and including: a light-emitting diode; a driving transistor controlling a current through the light-emitting diode based on a data signal from the data line; and a data transfer device connected to a first scan line and a second scan line among the scan lines and providing the data signal to a gate electrode of the driving transistor based on a first scan signal from the first scan line and a second scan signal from the second scan line, wherein the first scan signal has a turn-on voltage level during a first time period, and the second scan signal has a turn-on voltage level during a second time period different from the first time period, and wherein the driving transistor receives the data signal during the first time period and the second time period overlapping.

### CROSS REFERENCE TO RELATED APPLICATION

The present application claims priority to and the benefit of Korean Patent Application No. 10-2025-0063672, filed on May 16, 2025, in the Korean Intellectual Property Office, the entire disclosure of which is incorporated herein by reference.

### BACKGROUND

### 1. Field

Aspects of some embodiments of the present disclosure relate to a display panel, a display device, and an electronic device.

### 2. Description of the Related Art

A display device visually presents data on a screen to convey information to a user. To this end, the display device includes a plurality of pixels and a scan driving circuit. The scan driving circuit provides a plurality of scan signals through a plurality of scan lines to control the plurality of pixels. The duration of a turn-on time of a scan signal involved in data writing may determine the timing at which data is input to each pixel. Based on the written data signal, a driving current flows through each light-emitting diode, and each pixel emits light at a luminance (e.g., a set or predetermined luminance) in response to the driving current.

Meanwhile, when a pixel circuit operates in a source follow mode to compensate for a threshold voltage of a driving transistor, the source voltage of the driving transistor follows the gate voltage. Once a data signal is input, a change in the gate voltage may be transferred to the source voltage, thereby changing the driving current. Depending on the duration in which the data signal is input, that is, the turn-on time of the scan signal, the change in the driving current may be reflected in a subsequent frame, thereby causing a ghost phenomenon in which the pixel emits light at a luminance different from the target luminance value.

The above information disclosed in this Background section is only for enhancement of understanding of the background and therefore the information discussed in this Background section does not necessarily constitute prior art.

### SUMMARY

Aspects of some embodiments of the present disclosure relate to a display panel, a display device, and an electronic device. For example, aspects of some embodiments of the present disclosure relates to a display panel, a display device, and an electronic device configured to relatively improve display performance degradation that may occur during driving.

Aspects of some embodiments of the present disclosure are directed to providing a display panel, a display device, and an electronic device that are configured to control the turn-on time of scan signals such that a data signal is transferred during a single horizontal period, thereby minimizing or reducing the occurrence of ghost artifacts.

A display panel according to some embodiments of the present disclosure may include a pixel connected to at least one of a plurality of scan lines and a data line. According to some embodiments, the pixel may include a light-emitting diode, a driving transistor, and a data transfer device. According to some embodiments, the driving transistor may be configured to control an amount of current flowing through the light-emitting diode based on a data signal provided from the data line. According to some embodiments, the data transfer device may be connected to a first scan line and a second scan line among the plurality of scan lines and may be configured to transfer the data signal to a gate electrode of the driving transistor based on a first scan signal provided from the first scan line and a second scan signal provided from the second scan line. According to some embodiments, the first scan signal may have a turn-on voltage level during a first time period, and the second scan signal may have a turn-on voltage level during a second time period different from the first time period. According to some embodiments, the data signal may be transferred to the driving transistor during a time in which the first time period and the second time period overlap.

According to some embodiments, the first time period and the second time period may overlap by one horizontal period.

According to some embodiments, the data transfer device may include a first transistor and a second transistor. According to some embodiments, the first transistor may be configured to receive the data signal from the data line based on the first scan signal. According to some embodiments, the second transistor may be configured to receive the data signal from the first transistor based on the second scan signal and transfer the data signal to the driving transistor.

According to some embodiments, the first and second transistors may be N-type transistors.

According to some embodiments, the first time period and the second time period may each have a duration of two horizontal periods, and the second scan signal may be shifted by one horizontal period relative to the first scan signal.

According to some embodiments, the first time period and the second time period may each have a duration of four horizontal periods, and the second scan signal may be shifted by three horizontal periods relative to the first scan signal.

According to some embodiments, the pixel may further include a third transistor and a fourth transistor. According to some embodiments, the third transistor may be configured to provide a reference voltage to a first node based on a third scan signal provided through a third scan line. According to some embodiments, the fourth transistor may be configured to provide an initialization voltage to a second node based on a fourth scan signal provided through a fourth scan line. According to some embodiments, the first node may be electrically connected to the gate electrode of the driving transistor, and the second node may be electrically connected to an output electrode of the driving transistor.

According to some embodiments, the pixel may further include a fifth transistor and a sixth transistor. According to some embodiments, the fifth transistor may be configured to provide a driving voltage to an input electrode of the driving transistor based on a first emission signal provided through a first emission line. According to some embodiments, the sixth transistor may be configured to provide a driving current to the light-emitting diode based on a second emission signal provided through a second emission line and may be electrically connected between the second node and an anode electrode of the light-emitting diode.

According to some embodiments, the fifth transistor and the sixth transistor may be P-type transistors.

According to some embodiments, the driving transistor may include a body electrode electrically connected to the output electrode of the driving transistor. According to some embodiments, the pixel may further include a first capacitor and a second capacitor. According to some embodiments, the first capacitor may be electrically connected between the first node and the second node. According to some embodiments, the second capacitor may be electrically connected between a driving power line and the body electrode of the driving transistor.

A display device according to some embodiments of the present disclosure may include a display panel, a scan driving circuit, and a data driving circuit. According to some embodiments, the display panel may include a plurality of pixels connected to at least one of a plurality of scan lines and a data line. According to some embodiments, the scan driving circuit may be configured to provide a plurality of scan signals to the display panel through the plurality of scan lines. According to some embodiments, the data driving circuit may be configured to provide data signals to the display panel through the data line. According to some embodiments, among the plurality of pixels, a first pixel may include a light-emitting diode, a first transistor, a second transistor, and a third transistor. According to some embodiments, the first transistor may include a first electrode to which a driving voltage is supplied, a second electrode configured to output a driving current to the light-emitting diode, and a gate electrode configured to receive a data signal. According to some embodiments, the second transistor may include a first electrode electrically connected to the data line, a second electrode configured to output the data signal, and a gate electrode electrically connected to a first scan line among the plurality of scan lines. According to some embodiments, the third transistor may include a first electrode electrically connected to the second electrode of the second transistor, a second electrode electrically connected to the gate electrode of the first transistor, and a gate electrode electrically connected to a second scan line different from the first scan line among the plurality of scan lines. According to some embodiments, the second scan line may be electrically connected to the first pixel and a second pixel activated at a time different from the first pixel.

According to some embodiments, the scan driving circuit may be configured to provide a first scan signal configured to turn on the second transistor through the first scan line and a second scan signal configured to turn on the third transistor through the second scan line. According to some embodiments, the first scan signal and the second scan signal may have the same pulse width at a turn-on voltage level.

According to some embodiments, the data signal may be transferred to the gate electrode of the first transistor from a time when the third transistor is turned on based on the second scan signal until a time when the second transistor is turned off based on the first scan signal.

According to some embodiments, the data signal may be transferred to the gate electrode of the first transistor from a time when the second transistor is turned on based on the first scan signal until a time when the third transistor is turned off based on the second scan signal.

According to some embodiments, the second transistor and the third transistor may be N-type transistors.

According to some embodiments, the second pixel may include a light-emitting diode, a fourth transistor, a fifth transistor, and a sixth transistor. According to some embodiments, the fourth transistor may include a first electrode to which a driving voltage is supplied, a second electrode configured to output a driving current to the light-emitting diode, and a gate electrode configured to receive a data signal. According to some embodiments, the fifth transistor may include a first electrode electrically connected to the data line, a second electrode configured to output the data signal, and a gate electrode electrically connected to the second scan line. According to some embodiments, the sixth transistor may include a first electrode electrically connected to the second electrode of the fifth transistor, a second electrode electrically connected to the gate electrode of the fourth transistor, and a gate electrode electrically connected to a third scan line among the plurality of scan lines.

According to some embodiments, the first pixel may further include a fourth transistor, a fifth transistor, a sixth transistor, a seventh transistor, and a storage capacitor. According to some embodiments, the fourth transistor may be electrically connected between a reference power line and the gate electrode of the first transistor. According to some embodiments, the fifth transistor may be electrically connected between an initialization power line and an anode electrode of the light-emitting diode. According to some embodiments, the sixth transistor may be electrically connected between a driving power line and the first electrode of the first transistor. According to some embodiments, the seventh transistor may be electrically connected between the second electrode of the first transistor and the anode electrode of the light-emitting diode. According to some embodiments, the storage capacitor may be electrically connected between the gate electrode of the first transistor and the second electrode of the first transistor.

According to some embodiments, the first transistor may include a body electrode electrically connected to the second electrode of the first transistor. According to some embodiments, the first pixel may further include a holding capacitor electrically connected between the driving power line and the body electrode of the first transistor.

An electronic device according to some embodiments of the present disclosure may include a display panel. According to some embodiments, the display panel may include a pixel connected to at least one of a plurality of scan lines and a data line. According to some embodiments, the pixel may include a light-emitting diode, a driving transistor, and a data transfer device. According to some embodiments, the driving transistor may be configured to control an amount of current flowing through the light-emitting diode based on a data signal provided from the data line. According to some embodiments, the data transfer device may be connected to a first scan line and a second scan line among the plurality of scan lines and may be configured to transfer the data signal to a gate electrode of the driving transistor based on a first scan signal provided from the first scan line and a second scan signal provided from the second scan line. According to some embodiments, the first scan signal may have a turn-on voltage level during a first time period, and the second scan signal may have a turn-on voltage level during a second time period different from the first time period. According to some embodiments, the data signal may be transferred to the driving transistor during a time in which the first time period and the second time period overlap.

According to some embodiments, the electronic device may further include a processor, a memory, and a power module. According to some embodiments, the processor may be configured to execute an application to transfer an image data signal to the display panel. According to some embodiments, the memory may store data information for executing the application. According to some embodiments, the power module may be configured to supply power to the display panel, the processor, and the memory. According to some embodiments, the display panel may be configured to output image information based on the image data signal.

According to some embodiments of the present disclosure, a data signal may be transferred to the driving transistor during a single horizontal period (1H) through two switching transistors.

In addition, according to some embodiments of the present disclosure, by controlling the turn-on time of a scan signal involved in data writing, ghost artifacts may be minimized or reduced and image quality may be relatively improved.

### BRIEF DESCRIPTION OF THE DRAWINGS

These and/or other features will become more apparent and more readily appreciated from the following description of aspects of some embodiments of the present disclosure, taken in conjunction with the accompanying drawings in which:

FIG. 1 is a block diagram illustrating a display device according to some embodiments of the present disclosure;

FIG. 2 is a block diagram illustrating a display panel of the display device of FIG. 1;

FIG. 3 illustrates an equivalent circuit diagram of a pixel of an i-th row according to some embodiments of the present disclosure;

FIG. 4 is a waveform diagram for explaining aspects of some embodiments of the operation of the pixel shown in FIG. 3;

FIGS. 5A to 5E are diagrams for explaining the operation of a pixel according to some embodiments of the present disclosure;

FIG. 6A illustrates an equivalent circuit diagram illustrating aspects of some embodiments of the pixel shown in FIG. 3;

FIG. 6B is a waveform diagram for explaining aspects of some embodiments of the operation of the pixel shown in FIG. 6A;

FIG. 7A illustrates an equivalent circuit diagram according to some embodiments of the pixel shown in FIG. 3;

FIG. 7B is a waveform diagram for explaining aspects of some embodiments of the operation of the pixel shown in FIG. 7A;

FIG. 8 is a diagram for explaining a luminance difference according to a turn-on time of a scan signal in the display device according to some embodiments of the present disclosure;

FIG. 9 is a block diagram of an electronic device to which the display device according to some embodiments of the present disclosure is applied; and

FIG. 10 illustrates examples of electronic devices according to some embodiments of the present disclosure.

### DETAILED DESCRIPTION

References will now be made in more detail to aspects of some embodiments of the present disclosure, of which examples are illustrated in the accompanying drawings, where like reference numerals refer to like elements throughout. The embodiments may have a variety of forms and permutations, but the present disclosure shall by no means be construed as being limited to the described embodiments. Rather, the present disclosure shall be construed to encompass all forms, permutations, equivalents and substitutes covered by the technical ideas and scope of the present disclosure. Accordingly, the disclosed embodiments are merely described below, by referring to the figures, to aspects of some embodiments of the present disclosure.

Like or identical reference numerals refer to like or identical elements. Moreover, in the accompanying drawings, the thicknesses, ratios, and dimensions of the elements may not be to exact scale and may have been exaggerated for the benefit of effective explanation of the technical features associated with these elements. As such, the present disclosure shall not be restricted to the thicknesses, ratios, dimensions, etc. illustrated in the drawings.

When an element is described to be “located on,” “placed on,” “arranged on,” “connected to,” or “coupled to” another element, it shall be construed as being located on, placed on, arranged on, connected to, or coupled to the other element directly but also as possibly having another element therebetween. On the other hand, if one element is described to be “directly located on,” “directly placed on,” “directly arranged on,” “directly connected to,” or “directly coupled to” another element, it shall be construed that there is no other element interposed therebetween.

Moreover, relative terms, such as “below,” “under,” “beneath,” “lower,” “bottom,” “above,” “over,” “upper,” “top,” etc., may be used herein to describe one element's relationship to another element as illustrated in the accompanying figures. It shall be understood that relative terms are intended to encompass different orientations of the device in addition to the orientation depicted in the accompanying figures. For example, if the device in one of the figures is turned over, elements described as being on the “lower” side of the other elements would then be oriented on “upper” sides of the other elements. The term “lower” can therefore encompass an orientation of both “lower” and “upper,” depending on the particular orientation of the figure. Similarly, if the device in one of the figures is turned over, elements described as “below” or “beneath” other elements would then be oriented “above” the other elements. The term “below” or “beneath” can therefore encompass an orientation of both above and below.

Furthermore, when one device or layer is described to be “on,” “over,” “above,” and the like, another device or layer, it shall also encompass the case of yet another device or layer located on, over, above, and the like, the other device or layer or interposed between the one device or layer and the other device or layer. On the contrary, when one device or layer is described to be “directly on,” “directly over,” “directly above,” and the like, another device or layer, it shall mean that no other device or layer is interposed between the one device or layer and the other device or layer.

An expression such as “comprising” or “including” is intended to designate a characteristic, a number, a step, an operation, an element, a part or combinations thereof, and shall not be construed to preclude any possibility of presence or addition of one or more other characteristics, numbers, steps, operations, elements, parts or combinations thereof.

Unless otherwise defined, all terms, including technical terms and scientific terms, used herein have the same meaning as how they are generally understood by those of ordinary skill in the art to which the present disclosure pertains. Any term that is defined in a general dictionary shall be construed to have the same meaning in the context of the relevant art, and, unless otherwise defined explicitly, shall not be interpreted to have an idealistic or excessively formalistic meaning.

Terms such as “first” and “second” may be used in describing various elements, but the above elements shall not be restricted to the above terms. The above terms may be used only to distinguish one element from the other. For instance, the first element may be named the second element, and vice versa, without departing the scope of claims of the present disclosure. Unless clearly used otherwise, any expressions in a singular form may include a meaning of a plural form. The term “and/or” shall include the combination of a plurality of listed items or any of the plurality of listed items.

In the present disclosure, the term “electrically connected” includes being physically or directly connected, as well as being selectively connected through a switching element even when not physically connected. The switching element may be an electrical device, such as a transistor, integrated into the display device and may include a gate terminal (gate electrode), an input terminal (input electrode), and an output terminal (output electrode).

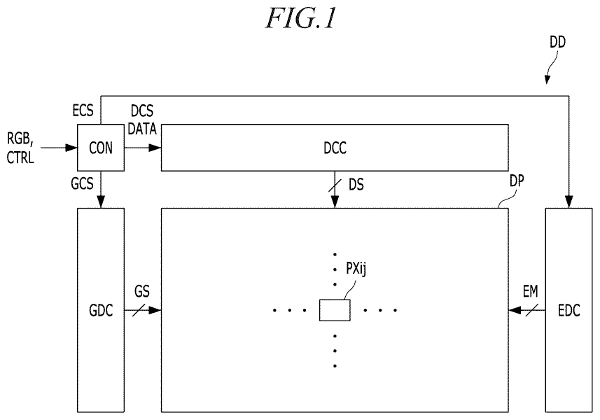

FIG. 1 is a block diagram illustrating a display device DD according to some embodiments of the present disclosure. Referring to FIG. 1, the display device DD includes a display panel DP, a scan driving circuit GDC, an emission driving circuit EDC, a data driving circuit DCC, and a driving controller CON. The display device DD is not limited to the components shown in FIG. 1 and may further include additional components. For example, the display device DD may further include a voltage generator configured to generate voltages required by the components including the display panel DP.

The driving controller CON receives image signals RGB and control signals CTRL. In one example, the image signals RGB and the control signals CTRL may be provided from an application processor. The image signals RGB may be understood as graphic sources of images to be displayed on the display panel DP. The control signals CTRL may include synchronization signals configured to synchronize the output of images at accurate positions on the display panel DP.

The driving controller CON generates image data signals DATA by converting the data format of the image signals RGB to match the interface specifications of the data driving circuit DCC. The driving controller CON may generate scan control signals GCS for controlling the scan driving circuit GDC, emission driving control signals ECS for controlling the emission driving circuit EDC, and data control signals DCS for controlling the data driving circuit DCC based on the control signals CTRL.

The display panel DP includes a plurality of pixels, each of which may emit light. Although FIG. 1 illustrates a single pixel PXij, as a person having ordinary skill in the art would appreciate, the display panel DP may include any suitable number of pixels PXij accord to the design and size of the display panel DP. Each pixel may be a pixel PXij located at an i-th row and a j-th column. The display panel DP is electrically connected to the scan driving circuit GDC through a plurality of scan lines and is electrically connected to the emission driving circuit EDC through a plurality of emission control lines. The plurality of scan lines and the plurality of emission control lines may extend in a first direction. The display panel DP is electrically connected to the data driving circuit DCC through a plurality of data lines, and the plurality of data lines may extend in a second direction intersecting the first direction.

The data driving circuit DCC receives the data control signals DCS and the image data signals DATA from the driving controller CON. The data driving circuit DCC may convert the image data signals DATA, which are digital signals, into data signals DS in an analog format. The data signals DS are converted to correspond to the gray-scale values of the image data signals DATA. The data driving circuit DCC may output the converted data signals DS to the plurality of pixels through the plurality of data lines.

The scan driving circuit GDC receives the scan control signals GCS from the driving controller CON. The scan driving circuit GDC may output scan signals GS to the scan lines based on the scan control signals GCS. The scan driving circuit GDC may sequentially activate the plurality of pixels row by row through the scan signals GS. In this context, activation refers to a state in which the plurality of pixels can receive the data signals DS through the data lines.

The emission driving circuit EDC receives the emission driving control signals ECS from the driving controller CON. The emission driving circuit EDC may output emission control signals EM to the emission control lines based on the emission driving control signals ECS. The emission driving circuit EDC may sequentially cause the plurality of pixels to emit light row by row through the emission control signals EM.

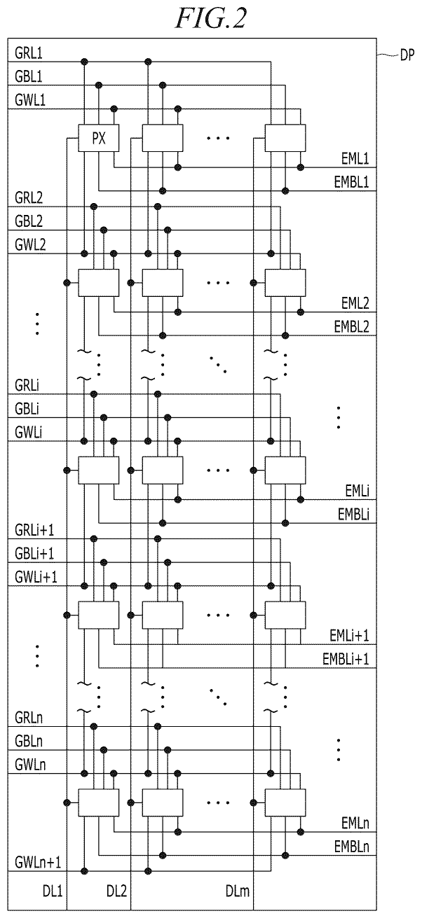

FIG. 2 is a block diagram illustrating the display panel DP of FIG. 1. Referring to FIG. 2, the display panel DP includes first scan lines GRL1 to GRLn, second scan lines GBL1 to GBLn, third scan lines GWL1 to GWLn, first emission lines EML1 to EMLn, second emission lines EMBL1 to EMBLn, data lines DL1 to DLm, and a plurality of pixels PX. The first scan lines GRL1 to GRLn, the second scan lines GBL1 to GBLn, and the third scan lines GWL1 to GWLn are connected to the scan driving circuit GDC (see FIG. 1) and may output scan signals based on scan control signals. The first emission lines EML1 to EMLn and the second emission lines EMBL1 to EMBLn are connected to the emission driving circuit EDC (see FIG. 1) and may output emission control signals based on emission driving control signals. The data lines DL1 to DLm are connected to the data driving circuit DCC (see FIG. 1) and may output data signals to the plurality of pixels.

The first scan lines GRL1 to GRLn, the second scan lines GBL1 to GBLn, the third scan lines GWL1 to GWLn, the first emission lines EML1 to EMLn, and the second emission lines EMBL1 to EMBLn extend in the first direction and are spaced apart from one another in the second direction intersecting the first direction. The data lines DL1 to DLm extend in the second direction and are spaced apart from one another in the first direction.

The plurality of pixels PX are electrically connected to the first scan lines GRL1 to GRLn, the second scan lines GBL1 to GBLn, the third scan lines GWL1 to GWLn, the first emission lines EML1 to EMLn, the second emission lines EMBL1 to EMBLn, and the data lines DL1 to DLm.

Each of the plurality of pixels PX may be electrically connected to four scan lines and two emission lines. As illustrated in FIG. 2, for example, the pixels in the first row may be connected to the scan lines GRL1, GBL1, GWL1, and GWL2 and the emission lines EML1 and EMBL1. That is, the pixels in the i-th row may be connected to the i-th scan lines GRLi, GBLi, and GWLi, the (i+1)-th third scan line GWLi+1, and the i-th emission lines EMLi and EMBLi. Accordingly, the pixels in the i-th row may be connected to the i-th third scan line GWLi and the (i+1)-th third scan line GWLi+1. In other words, the (i+1)-th third scan line GWLi+1 may be electrically connected to the pixels in the i-th row and the pixels in the (i+1)-th row that are activated at a time different from the pixels in the i-th row.

Although FIG. 2 illustrates that the pixels in the i-th row are connected to the i-th third scan line GWLi and the (i+1)-th third scan line GWLi+1, the configuration is not limited thereto. According to some embodiments of the present disclosure, the pixels in the i-th row may be connected to the i-th third scan line GWLi and the (i+3)-th third scan line GWLi+3. Alternatively, the pixels in the i-th row may be connected to the (i−1)-th third scan line GWLi−1 and the i-th third scan line GWLi. Various embodiments of the present disclosure will be described in detail below.

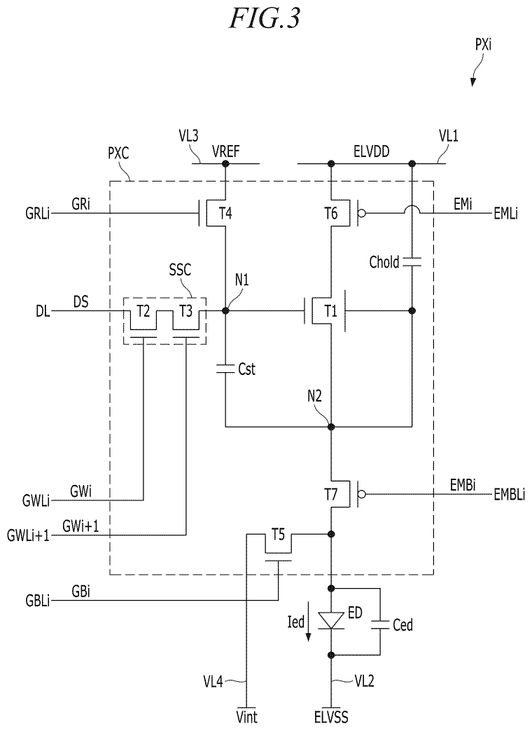

FIG. 3 illustrates an equivalent circuit diagram of a pixel PXi of the i-th row according to some embodiments of the present disclosure. Although FIG. 3 illustrates various components in a pixel according to some embodiments, embodiments according to the present disclosure are not limited thereto, and according to various embodiments, the pixel may include additional components, or fewer components, without departing from the spirit and scope of embodiments according to the present disclosure.

Referring to FIG. 3, the pixel PXi is electrically connected to the i-th first scan line GRLi among first scan lines GRL1 to GRLn, the i-th second scan line GBLi among second scan lines GBL1 to GBLn, the i-th and (i+1)-th third scan lines GWLi and GWLi+1 among third scan lines GWL1 to GWLn, the i-th first emission line EMLi among first emission lines EML1 to EMLn, and the i-th second emission line EMBLi among second emission lines EMBL1 to EMBLn. The pixel PXi corresponds to each of the plurality of pixels PX illustrated in FIG. 2.

Referring again to FIG. 3, the pixel PXi receives a first driving voltage ELVDD, a second driving voltage ELVSS, an initialization voltage Vint, and a reference voltage VREF. According to some embodiments, the first driving voltage ELVDD, the second driving voltage ELVSS, the initialization voltage Vint, and the reference voltage VREF may be provided using voltages generated by a power management circuit of the display device DD (see FIG. 1). For example, the initialization voltage Vint and the reference voltage VREF may be generated by the power management circuit and converted by the driving controller CON (see FIG. 1) before being transferred to the pixel PXi.

The pixel PXi includes a pixel circuit PXC, a light-emitting diode ED, and a capacitor Ced for the light-emitting diode. The pixel circuit PXC includes first to seventh transistors T1 to T7, a first capacitor Cst, and a second capacitor Chold. The second transistor T2 and the third transistor T3 may collectively represent a data transfer device SSC. In other embodiments of the present disclosure, the circuit configuration of the pixel PXi is not limited to FIG. 3 and may be implemented in various forms for emitting light from the light-emitting diode ED.

Each of the first to seventh transistors T1 to T7 may be a transistor having at least one semiconductor layer of an oxide semiconductor and a low-temperature polycrystalline silicon (LTPS) semiconductor. According to some embodiments of the present disclosure, the first to fifth transistors T1 to T5 may be N-type transistors, and the sixth and seventh transistors T6 and T7 may be P-type transistors.

The first transistor T1 includes a first electrode connected to a first driving voltage line VL1 via the sixth transistor T6, a second electrode electrically connected to an anode of the light-emitting diode ED via the seventh transistor T7, and a gate electrode connected to a second electrode of the third transistor T3. The first transistor T1 may receive a data signal DS transferred by a data line DL according to the switching operation of the data transfer device SSC and supply a driving current led to the light-emitting diode ED. The first transistor T1 may include a body electrode electrically connected to the second electrode of the first transistor T1.

Here, the gate electrode of the first transistor T1 is connected to a first node N1. The first transistor T1 may be turned on according to a voltage applied to the first node N1 and control a driving current led flowing from the first driving voltage ELVDD through the seventh transistor T7 to the light-emitting diode ED. According to some embodiments of the present disclosure, the first transistor T1 may be referred to as a driving transistor. The second electrode of the first transistor T1 is connected to a second node N2.

The second transistor T2 includes a first electrode connected to the data line DL, a second electrode connected to a first electrode of the third transistor T3, and a gate electrode connected to the i-th third scan line GWLi. The second transistor T2 may be turned on according to the i-th third scan signal GWi transferred through the i-th third scan line GWLi and transfer the data signal DS from the data line DL to the first electrode of the third transistor T3. The third scan line GWL connected to the gate electrode of the second transistor T2 is not limited to FIG. 3. For example, the gate electrode of the second transistor T2 may be connected to the (i+1)-th third scan line GWLi+1.

The third transistor T3 includes a first electrode connected to the second electrode of the second transistor T2, a second electrode connected to the gate electrode of the first transistor T1, and a gate electrode connected to the (i+1)-th third scan line GWLi+1. The third transistor T3 may be turned on according to the (i+1)-th third scan signal GWi+1 transferred through the (i+1)-th third scan line GWLi+1 and transfer the data signal DS transferred from the second transistor T2 to the gate electrode of the first transistor T1. The third scan line GWL connected to the gate electrode of the third transistor T3 is not limited to FIG. 3. For example, the gate electrode of the third transistor T3 may be connected to the i-th third scan line GWLi.

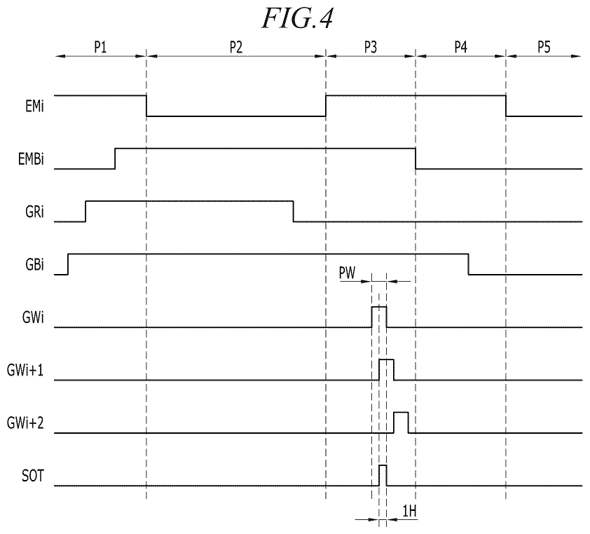

The data transfer device SSC may include the second transistor T2 and the third transistor T3. During the time in which the data transfer device SSC is turned on, that is, the time in which both the second transistor T2 and the third transistor T3 are turned on, the data signal DS may be transferred to the first transistor T1. The third scan lines GWL connected to the gate electrodes of the second and third transistors T2 and T3 are associated with the switching operation of the data transfer device SSC. The data transfer device SSC may include at least two transistors, but is not limited thereto. The switching operation of the data transfer device SSC will be described later with reference to FIG. 4.

The fourth transistor T4 includes a first electrode connected to a third voltage line VL3 to which the reference voltage VREF is transferred, a second electrode connected to the gate electrode of the first transistor T1, and a gate electrode connected to the i-th first scan line GRLi. The fourth transistor T4 may be turned on according to the first scan signal GRi transferred through the i-th first scan line GRLi and transfer the reference voltage VREF to the gate electrode of the first transistor T1. Accordingly, an initialization operation may be performed to initialize the voltage of the gate electrode of the first transistor T1 to the reference voltage VREF.

The fifth transistor T5 includes a first electrode connected to a fourth voltage line VL4 to which the initialization voltage Vint is transferred, a second electrode connected to the anode of the light-emitting diode ED, and a gate electrode connected to the i-th second scan line GBLi. The fifth transistor T5 may be turned on based on the second scan signal GBi transferred through the i-th second scan line GBLi and transfer the initialization voltage Vint to the anode of the light-emitting diode ED. Accordingly, the anode of the light-emitting diode ED may be initialized to the initialization voltage Vint.

The sixth transistor T6 includes a first electrode connected to the first driving voltage line VL1, a second electrode connected to the first electrode of the first transistor T1, and a gate electrode connected to the i-th first emission line EMLi. The sixth transistor T6 may be turned on according to the first emission signal EMi transferred through the i-th first emission line EMLi and transfer the first driving voltage ELVDD to the first transistor T1.

The seventh transistor T7 includes a first electrode connected to the second electrode of the first transistor T1, a second electrode connected to the anode of the light-emitting diode ED, and a gate electrode connected to the i-th second emission line EMBLi. The seventh transistor T7 may be turned on according to the second emission signal EMBi transferred through the i-th second emission line EMBLi.

The first capacitor Cst is electrically connected between the first node N1 and the second node N2. That is, one end of the first capacitor Cst is connected to the gate electrode of the first transistor T1, and the other end is connected to the second electrode of the first transistor T1. A voltage corresponding to a data voltage may be stored in the first capacitor Cst. The amount of current flowing through the first transistor T1 may be determined by the charge stored in the first capacitor Cst.

One end of the second capacitor Chold is connected to the first driving voltage line VL1, and the other end is connected to the body electrode of the first transistor T1. The voltage of the body electrode of the first transistor T1 may be held constant by the second capacitor Chold.

The light-emitting diode ED may emit light at a luminance (e.g., a set or predetermined luminance) based on the driving current led supplied from the pixel circuit PXC. To this end, the potential of the first driving voltage ELVDD may be set higher than the potential of the second driving voltage ELVSS. The cathode of the light-emitting diode ED may be connected to a second driving voltage line VL2 that transfers the second driving voltage ELVSS. For example, the light-emitting diode ED may be an organic light-emitting diode.

The light-emitting diode ED may include a capacitor Ced for the light-emitting diode, which uses the anode and the cathode of the light-emitting diode ED as electrodes. The capacitor Ced for the light-emitting diode may assist in maintaining the anode voltage of the light-emitting diode ED at a constant level.

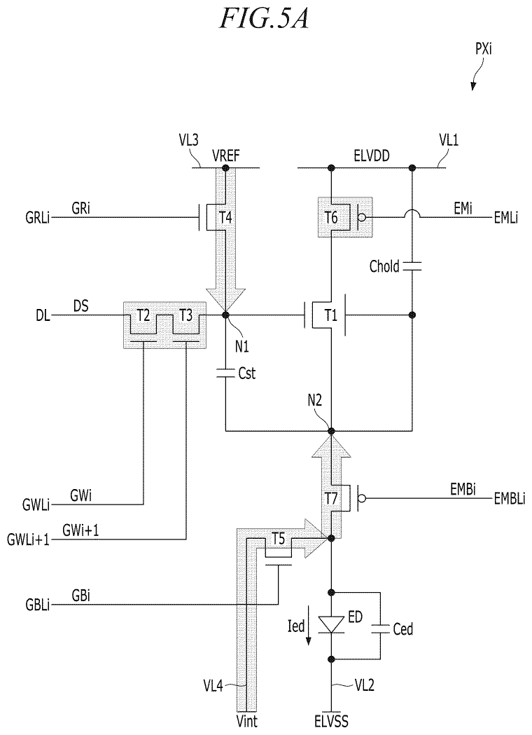

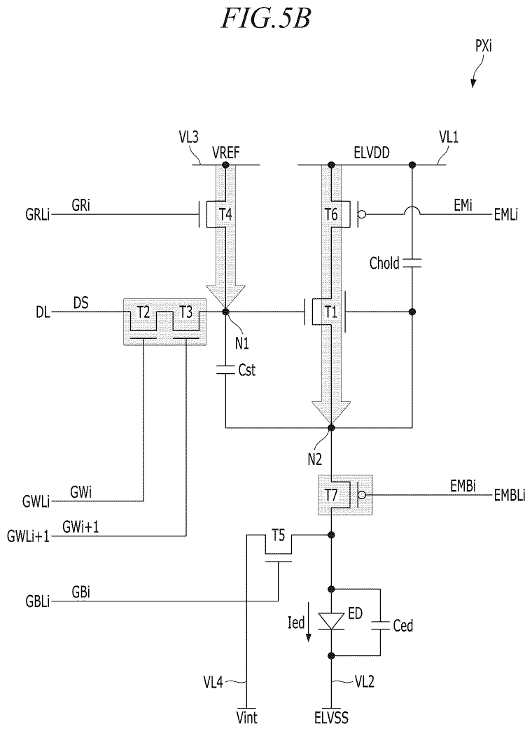

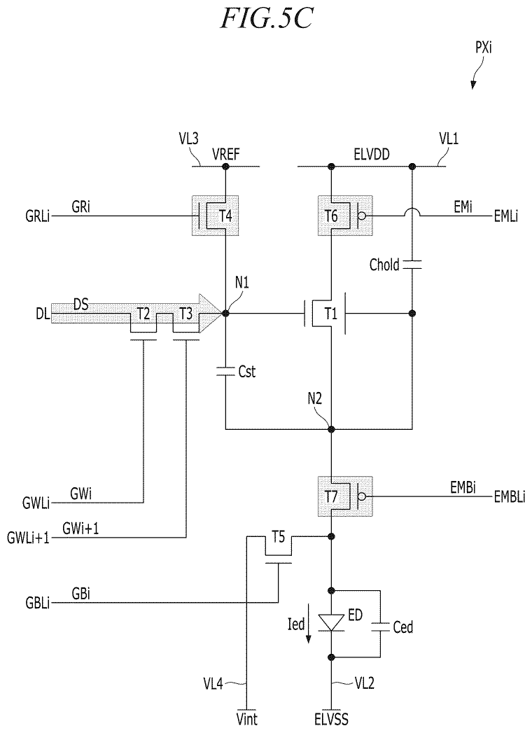

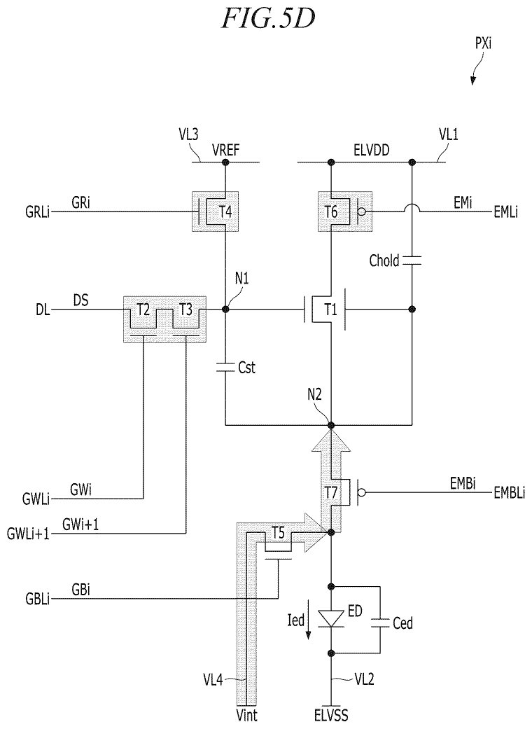

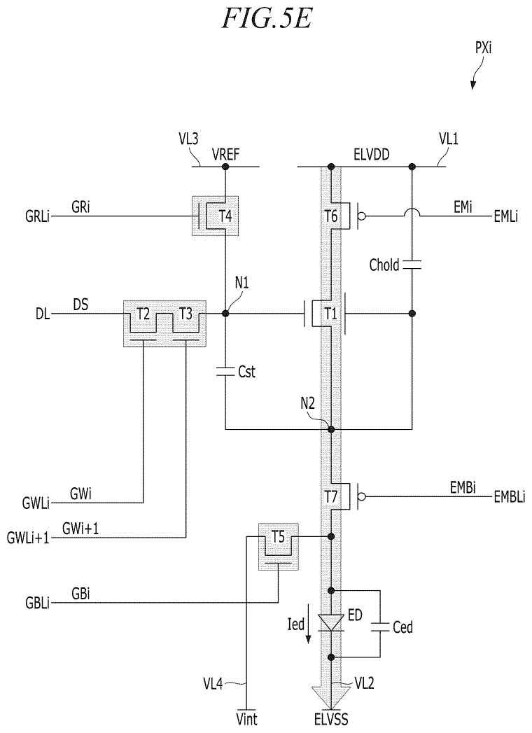

FIG. 4 is a waveform diagram for explaining aspects of the operation of the pixel illustrated in FIG. 3 according to some embodiments. FIGS. 5A to 5E are diagrams for explaining aspects of the operation of the pixel according to some embodiments of the present disclosure. The operation of the pixel will now be described with reference to FIG. 4 and FIGS. 5A to 5E. According to some embodiments of the present disclosure, the sixth transistor T6 and the seventh transistor T7 are P-type transistors, and the remaining transistors T1 to T5 are N-type transistors. Therefore, the turn-on and turn-off levels of the first emission signal EMi and the second emission signal EMBi may be opposite to those of the scan signals GRi, GBi, and GWi.

Referring first to FIG. 4, for the emission operation of the pixel, one frame sequentially includes a first period P1, a second period P2, a third period P3, a fourth period P4, and a fifth period P5. When the pixel belongs to the i-th row, the first emission signal EMi, the second emission signal EMBi, the first scan signal GRi, the second scan signal GBi, the i-th third scan signal GWi, and the (i+1)-th third scan signal GWi+1 may be applied to the pixel PXi. Here, i is a positive integer. For example, “GRi” may denote the first scan signal provided to the pixel PXi of the i-th row.

The first emission signal EMi may have a turn-off voltage level (or a high level) during the first period P1, the third period P3, and the fourth period P4, and may have a turn-on voltage level (or a low level) during the second period P2 and the fifth period P5. The second emission signal EMBi may have a turn-off voltage level during the second period P2 and the third period P3 and may have a turn-on voltage level during the fourth period P4 and the fifth period P5.

Referring to FIG. 4 and FIG. 5A, the pixel PXi is initialized during the first period P1. In the first period P1, the first scan signal GRi and the second scan signal GBi may have a turn-on voltage level (or a high level). In response to the first scan signal GRi at the turn-on voltage level, the fourth transistor T4 may be turned on, and the reference voltage VREF may be transferred to the gate electrode of the first transistor T1 through the fourth transistor T4.

In addition, in response to the second scan signal GBi at the turn-on voltage level, the fifth transistor T5 may be turned on, and the initialization voltage Vint may be transferred to the second electrode of the first transistor T1 through the seventh transistor T7, which may be turned on based on the second emission signal EMBi. Accordingly, the reference voltage VREF may be applied to the first node N1 connected to the gate electrode of the first transistor T1, and the initialization voltage Vint may be applied to the second node N2 connected to the second electrode of the first transistor T1, thereby initializing the first transistor T1.

Referring to FIG. 4 and FIG. 5B, the threshold voltage Vth of the first transistor T1 is compensated during the second period P2. In the second period P2, the first scan signal GRi may have a turn-on voltage level. When the reference voltage VREF is set to be greater than the initialization voltage Vint or the sum of the initialization voltage Vint and the threshold voltage Vth of the first transistor T1, the first transistor T1 may remain in the turned-on state.

In the second period P2, in response to the second scan signal GBi at the turn-on voltage level, the fifth transistor T5 may be turned on, and since the second emission signal EMBi has a turn-off voltage level, the seventh transistor T7 may be turned off. In such a case, the anode of the light-emitting diode ED may maintain the state initialized during the first period P1.

Meanwhile, in response to the first emission signal EMi at the turn-on voltage level, the sixth transistor T6 may be turned on. Accordingly, the voltage of the first node N1 may be maintained at the reference voltage VREF, and a compensation voltage (VREF−Vth), which is the voltage of the first node N1 reduced by the threshold voltage Vth, may be applied to the second node N2. Therefore, a voltage corresponding to the threshold voltage Vth of the first transistor T1 may be stored in the first capacitor Cst.

Referring to FIG. 4 and FIG. 5C, data is written into the pixel PXi during the third period P3. In the third period P3, the first scan signal GRi has a turn-off voltage level, and therefore the fourth transistor T4 may be turned off. In the third period P3, the i-th third scan signal GWi has a turn-on voltage level during a first time period, and in response, the second transistor T2 may be turned on during the first time period. The (i+1)-th third scan signal GWi+1 has a turn-on voltage level during a second time period, and in response, the third transistor T3 may be turned on during the second time period. The (i+1)-th third scan signal GWi+1 may be a signal shifted by one horizontal period (1H) relative to the i-th third scan signal GWi. Accordingly, the time SOT during which both the i-th third scan signal GWi and the (i+1)-th third scan signal GWi+1 have a turn-on voltage level, that is, the time during which the first and second time periods overlap, may be one horizontal period (1H).

The second transistor T2, which is turned on by the i-th third scan signal GWi, may transfer the data signal DS to the first electrode of the third transistor T3, and the third transistor T3, which is turned on by the (i+1)-th third scan signal GWi+1, may transfer the received data signal DS to the first node N1. That is, the data signal DS may be transferred to the gate electrode of the first transistor T1 during one horizontal period (1H), from the time when the third transistor T3 is turned on until the time when the second transistor T2 is turned off.

Although it is illustrated in FIG. 4 that the third scan signal GWi has a turn-on voltage level pulse width PW corresponding to two horizontal periods (2H), the configuration is not limited thereto. The pulse width PW of the turn-on voltage level of the third scan signal GWi may be longer than one horizontal period (1H). The turn-on time of the third scan signal GWi may be determined by the clock cycle of a scan driver of the display device. For example, when the clock cycle of the scan driver is four horizontal periods (4H), the pulse width PW of the turn-on voltage level of the third scan signal GWi may be at least four horizontal periods (4H). When the clock cycle of the scan driver is two horizontal periods (2H) or four horizontal periods (4H), the turn-on time of the third scan signal GWi will inevitably be longer than one horizontal period (1H).

Accordingly, when the data transfer device SSC (see FIG. 3) includes only one transistor, the data signal DS may be transferred to the first transistor T1 for a time longer than one horizontal period (1H). When data is written for a time longer than one horizontal period (1H), the voltage applied to the first node N1 fluctuates, and such variation may be reflected in the voltage between the first node N1 and the second node N2. The driving current flowing through the first transistor T1 may also be affected, and as a result, the luminance of the light emitted by the pixel PXi may differ from the luminance corresponding to the data signal DS.

As a result, when the time for inputting the data signal DS is longer than one horizontal period (1H), a ghost phenomenon may occur in which the pixel PXi emits light having a luminance different from the target luminance due to a difference in driving current caused by data written in the previous frame. The ghost phenomenon may deteriorate the image quality and display quality of the display device.

According to some embodiments of the present disclosure, the data transfer device SSC (see FIG. 3) may include the second transistor T2 and the third transistor T3. Accordingly, even when the clock cycle of the scan driver is longer than one horizontal period (1H), the data may be transferred to the first transistor T1 during one horizontal period (1H). The time in which data is written to the pixel PXi may be within one horizontal period (1H), but is not limited thereto.

As the turn-on time of the scan signal involved in data writing is controlled to be one horizontal period (1H) by the data transfer device SSC, the influence of the data written in the previous frame can be minimized or reduced. As a result, the pixel PXi can emit light having a luminance corresponding to the target luminance value, and ghost phenomena can be minimized or reduced.

Although FIG. 3 and FIG. 4 illustrate that the i-th third scan signal GWi is first applied to the second transistor T2 and then the (i+1)-th third scan signal GWi+1 is applied to the third transistor T3, the order in which the third scan signal GWi is applied is not limited to FIG. 3 and FIG. 4.

Referring to FIG. 4 and FIG. 5D, the pixel PXi is re-initialized during the fourth period P4. The voltage of the second node N2, which may fluctuate during the data writing process in the third period P3, may be initialized. In the fourth period P4, the second scan signal GBi may have a turn-on voltage level. Based on the second scan signal GBi, the initialization voltage Vint may be transferred to the second electrode of the first transistor T1 through the fifth transistor T5, which is turned on, and the seventh transistor T7, which is turned on based on the second emission signal EMBi.

In addition, the anode electrode of the light-emitting diode ED may be re-initialized by the initialization voltage Vint, or the capacitor Ced for the light-emitting diode may be charged by the initialization voltage Vint. In the fourth period P4, the pixel PXi may be in a ready state for light emission.

Referring to FIG. 4 and FIG. 5E, the pixel PXi emits light based on the written data signal DS during the fifth period P5. In the fifth period P5, both the first emission signal EMi and the second emission signal EMBi may have a turn-on voltage level. The sixth transistor T6 and the seventh transistor T7 may be turned on by the first emission signal EMi and the second emission signal EMBi, respectively.

Accordingly, a driving current led is generated according to the voltage difference between the voltage at the gate electrode of the first transistor T1 and the first driving voltage ELVDD, and the driving current led may be supplied to the light-emitting diode ED through the seventh transistor T7 so that the driving current led flows through the light-emitting diode ED. The light-emitting diode ED may emit light at a luminance corresponding to the driving current led.

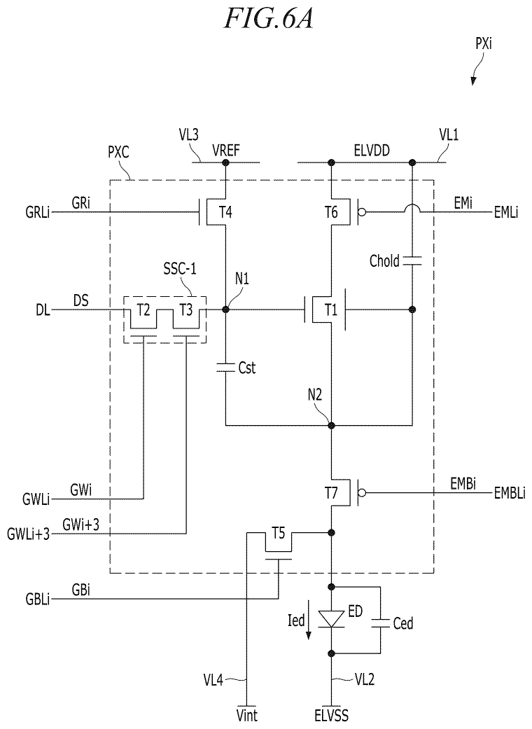

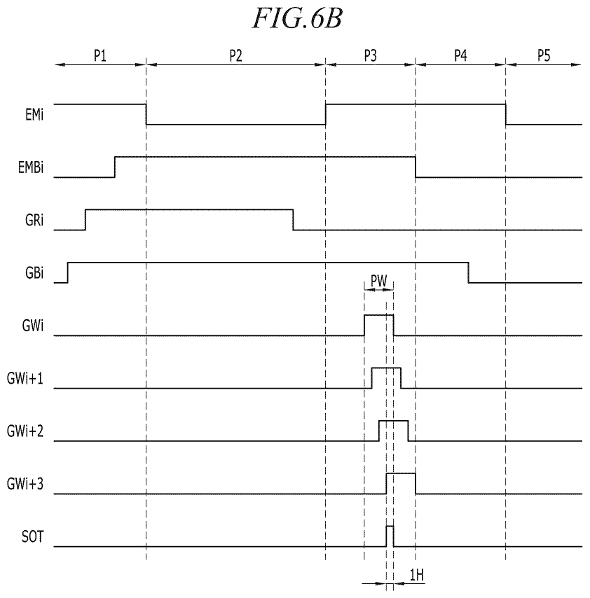

FIG. 6A illustrates an equivalent circuit diagram aspects of the pixel PXi of FIG. 3 according to some embodiments. Although FIG. 6A illustrates various components in a pixel according to some embodiments, embodiments according to the present disclosure are not limited thereto, and according to various embodiments, the pixel may include additional components, or fewer components, without departing from the spirit and scope of embodiments according to the present disclosure.

FIG. 6B is a waveform diagram for explaining aspects of the operation of the pixel shown in FIG. 6A according to some embodiments. Referring to FIG. 6A, the pixel PXi of FIG. 6A differs from the pixel PXi of FIG. 3 in the switching operation of the data transfer device SSC-1. The third transistor T3 may be connected to the (i+3)-th third scan line GWLi+3. Accordingly, the third transistor T3 may be turned on based on the (i+3)-th third scan signal GWi+3.

Referring to FIG. 6B, the third scan signal GWi may have a turn-on voltage level with a pulse width PW of four horizontal periods (4H). In addition, the (i+3)-th third scan signal GWi+3 may be a signal shifted by three horizontal periods (3H) relative to the i-th third scan signal GWi. Accordingly, the time SOT during which both the second and third transistors T2 and T3 are turned on may be one horizontal period (1H).

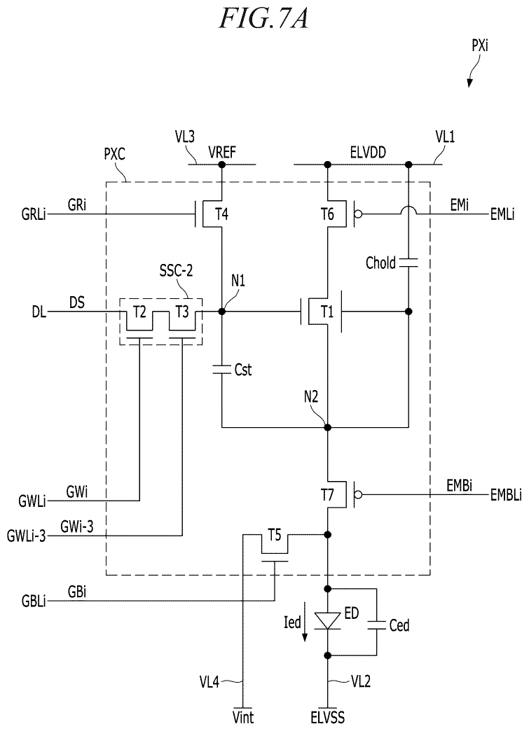

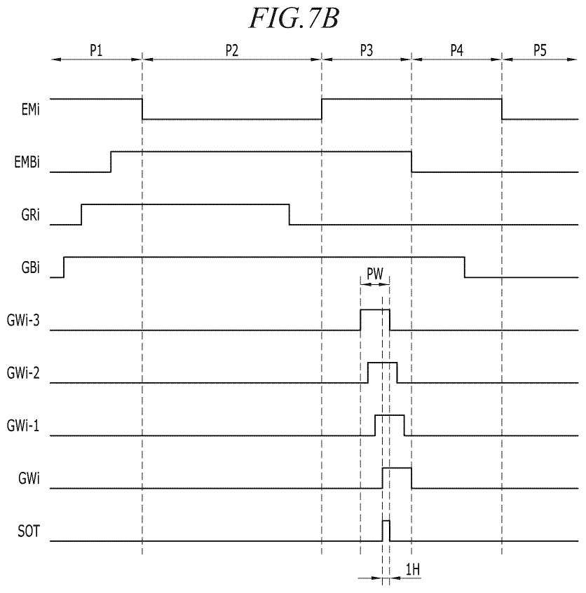

FIG. 7A illustrates an equivalent circuit diagram illustrating aspects of the pixel PXi shown in FIG. 3 according to some embodiments. Although FIG. 7A illustrates various components in a pixel according to some embodiments, embodiments according to the present disclosure are not limited thereto, and according to various embodiments, the pixel may include additional components, or fewer components, without departing from the spirit and scope of embodiments according to the present disclosure.

FIG. 7B is a waveform diagram for explaining aspects of the operation of the pixel shown in FIG. 7A according to some embodiments. Referring to FIG. 7A, the pixel PXi of FIG. 7A differs from the pixel PXi of FIG. 3 in the switching operation of the data transfer device SSC-2. The third transistor T3 may be connected to the (i−3)-th third scan line GWLi−3. Accordingly, the third transistor T3 may be turned on based on the (i−3)-th third scan signal GWi−3.

Referring to FIG. 7B, the third scan signal GWi may have a turn-on voltage level with a pulse width PW of four horizontal periods (4H). In addition, the i-th third scan signal GWi may be a signal shifted by three horizontal periods (3H) relative to the (i−3)-th third scan signal GWi−3. Accordingly, the time SOT during which both the second and third transistors T2 and T3 are turned on may be one horizontal period (1H).

As illustrated in FIG. 7B, when the third transistor T3 is turned on before the second transistor T2, the time SOT during which both the second and third transistors T2 and T3 are turned on may be from the time when the second transistor T2 is turned on until the time when the third transistor T3 is turned off. That is, the data signal DS may be transferred to the gate electrode of the first transistor T1 from the time when the second transistor T2 is turned on until the time when the third transistor T3 is turned off.

The design of the data transfer device SSC is not limited to FIG. 3, FIG. 6A, and FIG. 7A. The data transfer device SSC may be designed such that the data signal DS is transferred to the first transistor T1 for one horizontal period (1H) according to the pulse width PW of the turn-on voltage level of the third scan signal GW. The order in which the second and third transistors T2 and T3 are turned on by the third scan line GWL connected to each of the transistors and the third scan signal GW may vary.

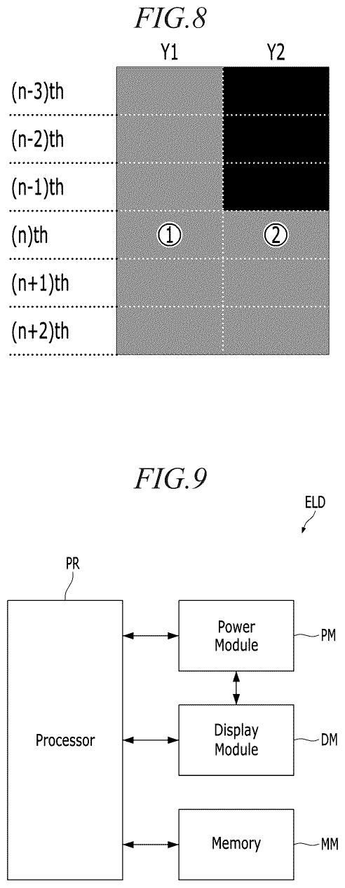

FIG. 8 is a diagram for explaining a luminance difference according to the turn-on time of a scan signal in the display device according to some embodiments of the present disclosure. Referring to FIG. 8, a first pixel Y1 and a second pixel Y2 may be understood as two adjacent pixels. In the case of the first pixel Y1, the same data signal is applied in every frame, and the pixel may emit light at the same luminance. In contrast, in the case of the second pixel Y2, data is written from the (n−3)-th frame to the (n−1)-th frame to display a black image, and a driving current having a minimum current may flow through the first transistor T1 (see FIG. 3) of the second pixel Y2. From the n-th frame to the (n+2)-th frame, the same data signal as that applied to the first pixel Y1 is also applied to the second pixel Y2.

Accordingly, it is desirable that the luminance Y1_n displayed by the first pixel Y1 and the luminance Y2_n displayed by the second pixel Y2 in the n-th frame are identical. The smaller the difference in luminance Y1_n and Y2_n between the respective pixels, the better the display performance of the display device can be considered. The luminance difference between the first and second pixels in the n-th frame can be expressed as Equation 1. A larger luminance difference can be understood to correspond to a more pronounced ghost phenomenon.

$$\frac{Y2\_n - Y1\_n}{Y2\_n} [ \% ] \qquad Equation 1$$

To verify the display performance of the display device according to the turn-on time of the scan signal, the luminance difference in the n-th frame was compared through simulation between a first display device and a second display device having different turn-on times of the scan signal. Here, the first display device has a scan signal turn-on time longer than one horizontal period (1H), and the second display device has a scan signal turn-on time lasting one horizontal period (1H). According to some embodiments of the present disclosure, the second display device may include the data transfer device SSC (see FIG. 3), and the data signal may be transferred to the gate electrode of the first transistor T1 during one horizontal period (1H).

TABLE 1

| Gray Value | First Display Device | Second Display Device |
|---|---|---|
| 255 | 16.57% | −0.05% |
| 127 | 10.45% | 3.79% |
| 64 | 1.96% | 1.67% |
| 32 | 0.26% | 0.29% |

When the gray values corresponding to the data signals written in the n-th frame are 255, 127, 64, and 32, respectively, the luminance difference Y1_n and Y2_n between the first and second pixels of the first and second display devices confirmed through simulation is shown in Table 1 above. A larger gray value indicates brighter white light, and the luminance difference between the (n−1)-th frame and the n-th frame in the second pixel Y2 increases as the gray value increases.

Referring to Table 1, it can be confirmed that in the first display device, the luminance difference Y1_n and Y2_n between the first and second pixels in the n-th frame increases as the gray value increases. As the data signal is written for a time longer than one horizontal period (1H) in the first display device, a ghost phenomenon can be understood to occur since the data for the black image written in the (n−1)-th frame is also reflected in the n-th frame. When the gray value is 255, the first display device exhibits a luminance difference of up to 16.57%, indicating that the ghost phenomenon is clearly present.

In contrast, the second display device, in which the turn-on time of the scan signal is equal to one horizontal period (1H), exhibits a reduced luminance difference Y1_n and Y2_n between the first and second pixels in the n-th frame compared to the first display device. The second display device exhibits the maximum luminance difference of 3.79%, showing that the ghost phenomenon is minimized or reduced.

As a result, by using the data transfer device SSC including at least two transistors, data can be written into the pixel for one horizontal period (1H) even when the pulse width of the scan signal involved in data writing is longer than one horizontal period (1H), and the ghost phenomenon can thus be minimized or reduced.

The display device according to embodiments of the present disclosure can be applied to various electronic devices. An electronic device according to some embodiments may include the above-described display device and may further include modules or devices having additional functions besides the display device.

FIG. 9 is a block diagram of an electronic device to which a display device according to some embodiments of the present disclosure is applied. Referring to FIG. 9, an electronic device ELD according to some embodiments may include a display module DM, a processor PR, a memory MM, and a power module PM.

The processor PR may include at least one of a central processing unit (CPU), an application processor (AP), a graphic processing unit (GPU), a communication processor (CP), an image signal processor (ISP), or a controller.

The memory MM may have data information necessary for the operation of the processor PR or the display module DM stored therein. When the processor PR executes an application stored in the memory MM, image data signals and/or input control signals may be transferred to the display module DM, which then may process the provided signals and output image information through a display screen.

The power module PM may include a power supply module, such as a power adapter or a battery device, and a power conversion module configured to convert power supplied by the power supply module to generate power required for operating the electronic device ELD.

At least one of the components of the electronic device ELD described above may be included within the display device according to the embodiments described above. In addition, some of the individual modules included functionally in a single module may be integrated into the display device, while others may be provided separately from the display device. For example, the display device may include the display module DM, while the processor PR, the memory MM, and the power module PM may be provided as other devices within the electronic device ELD rather than in the display device.

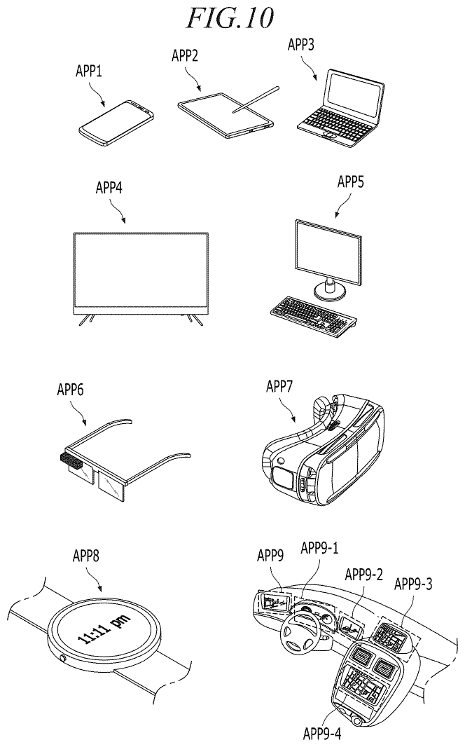

FIG. 10 illustrates various electronic devices ELD according to embodiments of the present disclosure. Referring to FIG. 10, the various electronic devices ELD to which the display device according to the embodiments is applied may include not only image display electronic devices, such as a smartphone APP1, a tablet PC APP2, a laptop computer APP3, a TV APP4, and a desktop monitor APP5, but also wearable electronic devices including a display module, such as smart glasses APP6, a head-mounted display APP7, and a smartwatch APP8, as well as automotive electronic devices APP9 to APP9-4 including the display panel, such as an instrument panel, a center fascia, a dashboard-mounted CID (Center Information Display), or a room mirror display.

The electronic or electric devices and/or any other relevant devices or components according to embodiments of the present invention described herein may be implemented utilizing any suitable hardware, firmware (e.g. an application-specific integrated circuit), software, or a combination of software, firmware, and hardware. For example, the various components of these devices may be formed on one integrated circuit (IC) chip or on separate IC chips. Further, the various components of these devices may be implemented on a flexible printed circuit film, a tape carrier package (TCP), a printed circuit board (PCB), or formed on one substrate. Further, the various components of these devices may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the spirit and scope of the disclosed embodiments of the present invention.

While certain aspects of some embodiments of the present disclosure have been described herein, as a person having ordinary skill in the art to which the present disclosure pertains would appreciate that there may be a variety of modifications and permutations of the embodiments according to present disclosure without departing from the spirit and scope of embodiments according to the present disclosure that are defined in the appended claims, and their equivalents. Moreover, it shall be appreciated that the disclosed embodiments are not intended to restrict the present disclosure thereto and that every technical idea within the appended claims and their equivalents is interpreted to be included in the scope of embodiments according to the present disclosure.

What is claimed is:

1. A display panel comprising:
a pixel connected to at least one of a plurality of scan lines and a data line,
wherein the pixel comprises:
a light-emitting diode;
a driving transistor configured to control an amount of current flowing through the light-emitting diode based on a data signal provided from the data line; and
a data transfer device connected to a first scan line and a second scan line among the plurality of scan lines and configured to provide the data signal to a gate electrode of the driving transistor based on a first scan signal provided from the first scan line and a second scan signal provided from the second scan line,
wherein the first scan signal has a turn-on voltage level during a first time period, and the second scan signal has a turn-on voltage level during a second time period different from the first time period, and
wherein the driving transistor is configured to receive the data signal during a time in which the first time period and the second time period overlap.

2. The display panel of claim 1, wherein the first time period and the second time period overlap by one horizontal period.

3. The display panel of claim 2, wherein the data transfer device comprises:
a first transistor configured to receive the data signal from the data line based on the first scan signal; and
a second transistor configured to receive the data signal from the first transistor based on the second scan signal and transfer the data signal to the driving transistor.

4. The display panel of claim 3, wherein the first transistor and the second transistor are N-type transistors.

5. The display panel of claim 3, wherein the first time period and the second time period each have a length of two horizontal periods, and
wherein the second scan signal is shifted by one horizontal period relative to the first scan signal.

6. The display panel of claim 3, wherein the first time period and the second time period each have a length of four horizontal periods, and
wherein the second scan signal is shifted by three horizontal periods relative to the first scan signal.

7. The display panel of claim 1, wherein the pixel further comprises:
a third transistor configured to provide a reference voltage to a first node based on a third scan signal through a third scan line; and
a fourth transistor configured to provide an initialization voltage to a second node based on a fourth scan signal through a fourth scan line,
wherein the first node is electrically connected to the gate electrode of the driving transistor, and
wherein the second node is electrically connected to an output electrode of the driving transistor.

8. The display panel of claim 7, wherein the pixel further comprises:
a fifth transistor configured to provide a driving voltage to an input electrode of the driving transistor based on a first emission signal through a first emission line; and
a sixth transistor configured to provide a driving current to the light-emitting diode based on a second emission signal through a second emission line and electrically connected between the second node and an anode electrode of the light-emitting diode.

9. The display panel of claim 8, wherein the fifth transistor and the sixth transistor are P-type transistors.

10. The display panel of claim 7, wherein the driving transistor comprises a body electrode electrically connected to the output electrode of the driving transistor, and
wherein the pixel further comprises:
a first capacitor electrically connected between the first node and the second node; and
a second capacitor electrically connected between a driving power line and the body electrode of the driving transistor.

11. A display device comprising:
a display panel including a plurality of pixels connected to at least one of a plurality of scan lines and a data line;
a scan driving circuit configured to provide a plurality of scan signals to the display panel through the plurality of scan lines; and
a data driving circuit configured to provide a data signal to the display panel through the data line,
wherein a first pixel among the plurality of pixels comprises:
a light-emitting diode;
a first transistor including a first electrode configured to receive a driving voltage, a second electrode configured to output a driving current to the light-emitting diode, and a gate electrode configured to receive the data signal;
a second transistor including a first electrode electrically connected to the data line, a second electrode configured to output the data signal, and a gate electrode electrically connected to a first scan line among the plurality of scan lines; and
a third transistor including a first electrode electrically connected to the second electrode of the second transistor, a second electrode electrically connected to the gate electrode of the first transistor, and a gate electrode electrically connected to a second scan line among the plurality of scan lines different from the first scan line, and
wherein the second scan line is electrically connected to the first pixel and a second pixel activated at a time different from the first pixel.

12. The display device of claim 11, wherein the scan driving circuit is configured to provide a first scan signal through the first scan line to turn on the second transistor and a second scan signal through the second scan line to turn on the third transistor, and
wherein the first scan signal and the second scan signal have a same pulse width at a turn-on voltage level.

13. The display device of claim 12, wherein the gate electrode of the first transistor is configured to receive the data signal from a time when the third transistor is turned on based on the second scan signal to a time when the second transistor is turned off based on the first scan signal.

14. The display device of claim 12, wherein the gate electrode of the first transistor is configured to receive the data signal from a time when the second transistor is turned on based on the first scan signal to a time when the third transistor is turned off based on the second scan signal.

15. The display device of claim 11, wherein the second transistor and the third transistor are N-type transistors.

16. The display device of claim 11, wherein the second pixel comprises:
a light-emitting diode;
a fourth transistor including a first electrode configured to receive the driving voltage, a second electrode configured to output a driving current to the light-emitting diode, and a gate electrode configured to receive the data signal;
a fifth transistor including a first electrode electrically connected to the data line, a second electrode configured to output the data signal, and a gate electrode electrically connected to the second scan line; and
a sixth transistor including a first electrode electrically connected to the second electrode of the fifth transistor, a second electrode electrically connected to the gate electrode of the fourth transistor, and a gate electrode electrically connected to a third scan line among the plurality of scan lines.

17. The display device of claim 11, wherein the first pixel further comprises:
a fourth transistor electrically connected between a reference power line and the gate electrode of the first transistor;
a fifth transistor electrically connected between an initialization power line and an anode electrode of the light-emitting diode;
a sixth transistor electrically connected between a driving power line and the first electrode of the first transistor;
a seventh transistor electrically connected between the second electrode of the first transistor and the anode electrode of the light-emitting diode; and
a storage capacitor electrically connected between the gate electrode of the first transistor and the second electrode of the first transistor.

18. The display device of claim 11, wherein the first transistor comprises a body electrode electrically connected to the second electrode of the first transistor, and
wherein the first pixel further comprises a holding capacitor electrically connected between a driving power line and the body electrode of the first transistor.

19. An electronic device comprising: a display panel including a pixel connected to at least one of a plurality of scan lines and a data line,
wherein the pixel comprises:
a light-emitting diode;
a driving transistor configured to control an amount of current flowing through the light-emitting diode based on a data signal provided from the data line; and
a data transfer device connected to a first scan line and a second scan line among the plurality of scan lines and configured to provide the data signal to a gate electrode of the driving transistor based on a first scan signal provided from the first scan line and a second scan signal provided from the second scan line,
wherein the first scan signal has a turn-on voltage level during a first time period, and the second scan signal has a turn-on voltage level during a second time period different from the first time period, and
wherein the driving transistor is configured to receive the data signal during a time in which the first time period and the second time period overlap.

20. The electronic device of claim 19, further comprising:
a processor configured to execute an application to transfer an image data signal to the display panel;
a memory in which data information for executing the application is stored; and
a power module configured to supply power to the display panel, the processor, and the memory,
wherein the display panel is configured to output image information based on the image data signal.
